(19) United States
(12) Patent Application Publication
(10) Pub. No.: US 2014/0004822 A1
(43) Pub. Date: Jan. 2, 2014

(54) SYSTEM AND METHOD FOR PROVIDING LOCATION-RELATED INFORMATION

(71) Applicant: Electronics and Telecommunications Research Institute, Daejeon (KR)

(72) Inventors: Kang-Yong LEE, Daejeon (KR); Kang-Suk HUH, Chungcheongbuk-do (KR); Kee-Seong CHO, Daejeon (KR); Won RYU, Daejeon (KR)

(21) Appl. No.: 13/922,210

(22) Filed: Jun. 19, 2013

(30) Foreign Application Priority Data
Jun. 29, 2012 (KR) 10-2012-0071340

(51) Int. Cl. H04W 4/02

(52) U.S. Cl. CPC H04W 4/02
USPC 455/406; 455/456.3

(57) ABSTRACT

A method of providing location-related information in an explorer information management server is provided. The method includes receiving registration of current locations of explorers, searching for the explorers in a specific region according to a request for search for the explorers in the specific region from a requester, transmitting a list of explorers according to the search to a requester terminal, requesting an explorer selected by the requester to provide information as explorer selection information is received from the requester terminal, and receiving the information from the explorer and transmitting the information to the requester terminal.

### CROSS-REFERENCE TO RELATED APPLICATION

This application claims the benefit under 35 U.S.C. §119(a) of a Korean Patent Application No. 10-2012-0071340, filed on Jun. 29, 2012, in the Korean Intellectual Property Office, the entire disclosure of which is incorporated herein by reference for all purposes.

### BACKGROUND

1. Field

The following description relates to an apparatus and method for providing location-based service, and more particularly, to a system and method that enable a user to acquire information of a region of interest in real time without having to visit the region.

2. Description of the Related Art

Conventionally, location-based services have attracted a lot of attentions due to their advantage of being able to provide desired service in a region in which a user is currently located, using location information.

In other words, technology for searching for and providing optimal stores, goods or services based on a current location of a user using a matter of concern and preference is already being provided through many services.

In particular, with the recent explosive growth in use of mobile devices such as smart phones or tablet PCs equipped with a global positioning system (GPS) and with the high accuracy of positioning, services that take advantage of location information increase rapidly.

However, conventional location-based services are provided based on information that has been specified by a service provider for each region in advance. In other words, generally, the service provider registers information or services for each region (or location), which can be provided by the service provider in the region, in advance, and provides the information or the services when the user is located in the region. Examples of the service may include restaurant search service, coupon search service, and shop search service.

Thus, information that can be acquired by the user is limited to the information that has been registered by the service provider based on the location in advance, and information cannot be acquired from regions not specified by the service provider.

### SUMMARY

The following description provides an apparatus and method for acquiring information from users currently located in a specific location and providing users located in a specific location with the information acquired from the users, in real time.

According to the present invention, a user who is interested in a specific region can request and acquire useful information and desired information from other users currently located in the region, in real time.

In addition, users having provided the information can charge a certain cost from the user having requested to provide the information.

The present invention proposes a method capable of providing useful information acquired from a specific location using location information of users to other users in real time or sharing the useful information with the other users.

According to the present invention, a user can acquire useful information in real time in advance without having to actually visit the region of interest or desired to travel.

The following description is directed to a method and a system in which useful information of a specific location (or a remote place) is acquired based on location information and transmitted to users desiring the information in real time so that the information can be provided or shared.

The present invention may be applied to, particularly, travel-related business models. A user can acquire and utilize useful information and desired information of a region in which the user is desired to travel or a region of interest from other users in real time in advance without actually having to visit the region.

In one general aspect, there is provided a method of providing location-related information in an explorer information management server, the method including: receiving registration of current locations of explorers; searching for the explorers in a specific region according to a request for search for the explorers in the specific region from a requester; transmitting a list of explorers according to the search to a requester terminal; requesting an explorer selected by the requester to provide information as explorer selection information is received from the requester terminal; and receiving the information from the explorer and transmitting the information to the requester terminal.

Other features and aspects will be apparent from the following detailed description, the drawings, and the claims.

### BRIEF DESCRIPTION OF THE DRAWINGS

FIG. 1 is a diagram illustrating a configuration of a system for providing location-related information according to a preferred embodiment of the present invention; and

FIG. 2 is a signal flow diagram illustrating a method of providing location-related information according to a preferred embodiment of the present invention.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The present invention according to a preferred embodiment will be described in detail with reference to the accompanying drawings.

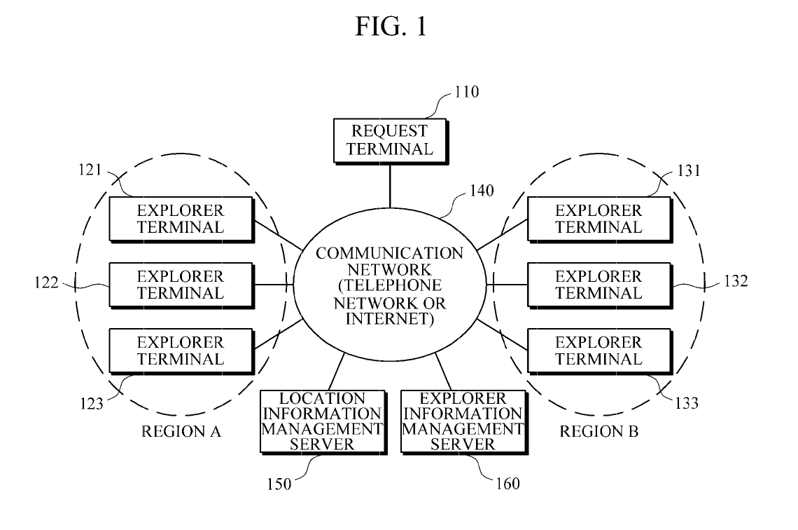

FIG. 1 is a diagram illustrating a configuration of a system for providing location-based information according to a preferred embodiment of the present invention.

Referring to FIG. 1, a system for providing location-based information has a configuration in which one or more terminals 110, . . . , 133, a billing information management server 150, and an explorer information management server 160 are connected via a wired/wireless network 140.

In the present invention, the terminals 110, . . . , 133 may be divided into a requester terminal 110 and explorer terminals 121, . . . , 133.

The requester terminal 110 is a terminal owned by a user that is interested in a specific region and desires to acquire information related to the region. The requester terminal 110 is a terminal that may consume information received from explorers, and includes a personal computer (PC), an Internet protocol television (IPTV), a smart TV, a smart phone, or a tablet PC.

The explorer terminals 121, 122, 123, 131, 131 and 133 are terminals owned by users located in specific regions and holding information related to the regions. The explorer terminals are mobile terminals equipped with a GPS or any other location identification device capable of identifying their locations, such as smart phones or tablet PCs.

The explorer terminals 121, 122, and 123 refer to users currently located in region A, and the explorer terminals 131, 132, 133 refer to users currently located in region B. Explorers register their current locations in the location information management server 150 to be searched for by the requester.

The billing information management server 170 is a server responsible for settlement and payment of a cost that is paid when the requester requests the explorer to collect information. The requester pays a request cost to the billing information management server, and the explorer receives the request cost as a reward for information provision from the billing information management server.

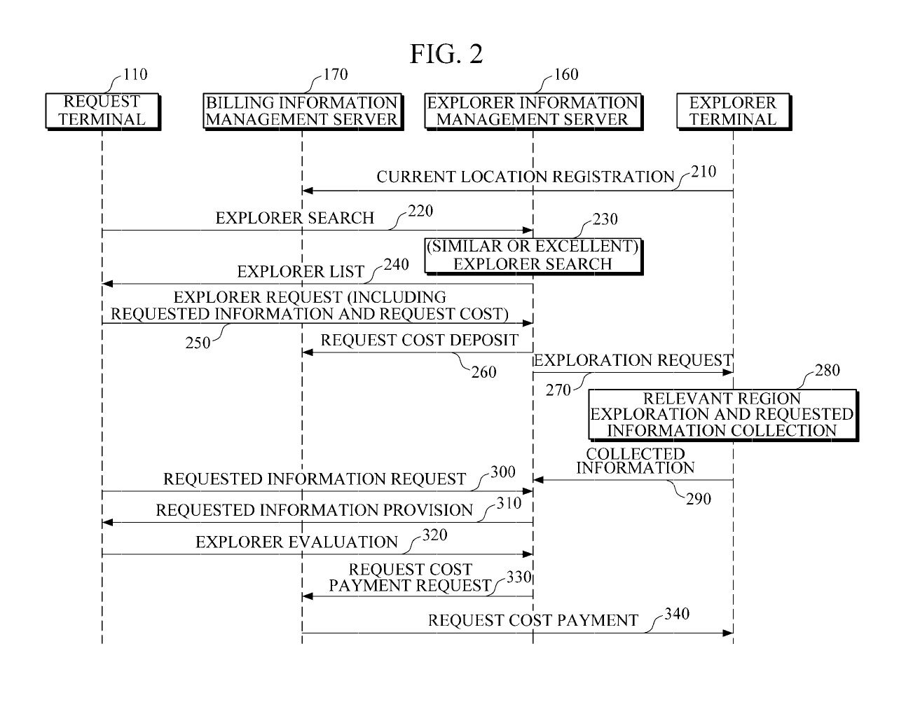

The explorer information management server 160 provides the requester with information held by the explorer, including personal information of the explorer, exploration information of the explorer, and information of an evaluation score (hereinafter, exploration reliability) for the information provided by the explorer. This will be described in detail with reference to FIG. 2.

The wired/wireless communication network 140 refers to a data network that enables the requester terminal 110 and the explorer terminals 121, . . . , 133 to communicate with each other in real time, such as an existing telephone network or the Internet.

FIG. 2 is a diagram illustrating a method of providing location-related information according to a preferred embodiment of the present invention.

Referring to FIG. 2, the explorer terminals register their current locations in the explorer information management server 160 in operation 210. The explorer information management server 160 stores location information of one or more explorer terminals.

The requester terminal 110 requests search for explorers located in a region of interest in operation 220. The explorer information management server then searches for the explorers to search for similar or excellent explorers in operation 230. Further, the explorer information management server transmits an explorer list according to the search to the requester terminal in operation 240. Thus, the requester acquires a list of explorers located in the region of interest, based on the explorer list. For example, if the requester is interested in region A, the requester may acquire a list from the explorer 121 to the explorer 123, and if the requester is interested in region B, the requester may acquire a list from the explorer 131 to the explorer 133.

The requester terminal 110 selects the explorers having a similar inclination to the requester from the explorer list acquired from the explorer information management server 160 or selects explorers having excellent evaluation score. Alternatively, the requester terminal 110 may select all the explorers located in the relevant region.

In this case, there are various criteria for selection of the explorers by the requester, but, in the present invention, the explorers are selected as follows:

A. Explorers having provided information whose evaluation has been excellent in the past (explorers having excellent exploration reliability)

B. Explorers having a similar inclination to the requester.

C. All explorers in a relevant region.

In the case of A among the criteria for selection of explorers, the explorers refer to explorers having provided information whose evaluation by the requester has been excellent in the past.

Since the location information management server 150 includes exploration reliability information of explorers, the requester may use the information in an explorer search operation. Accordingly, the requester can acquire the highest quality information by selecting the most reliable explorer (an explorer having the most excellent reliability) among a number of explorers.

In the case of B, the explorers refer to users having a similar service use inclination to the requester. The users having a similar service use inclination refer to explorers similar to the requester in visited regions or information of interest in the visited regions.

For example, two users who visit a coastal region may be regarded to be similar, or users interested in lodging information in a coastal region may be regarded to be similar. A user can acquire more useful and most suitable information by selecting an explorer having a similar inclination to the user. In this case, since calculation or estimation of similarity between users is not the object of the present invention, a detailed description thereof will be omitted.

In the case of C, a requester selects all explorers located in a relevant region. The requester can acquire various pieces of information by selecting a number of explorers.

Further, the requester terminal 110 deposits a request cost to the explorer information management server 160 and also requests the explorer information management server 160 to perform information search in operation 250. The requester may select one of the explorers and request the explorer to collect information of a relevant region. In this case, a certain cost may be paid to the explorer. The requester deposits a request cost for the explorer to the billing information management server 150 so that the cost can be paid to the explorer when the explorer has provided the information. Since specific settlement, calculation or the like for the cost paid to the explorer by the requester as a reward for the request is not included in the scope of the present invention, a detailed description thereof will be omitted.

The explorer information management server 160 then deposits the request cost received from the requester to the billing information management server 150 in operation 260, and requests the explorer selected by the requester to perform exploration in operation 270.

The explorer terminal 121 explores the relevant region and collects the requested information in operation 280.

The explorer having received the request collects the following information in the region.

(A) Basic Information

(B) Request Information

As the information collected by the explorer having received the request from the requester, the basic information (A) refers to basic information of the region. In this case, the basic information may be primary facility information, transportation, picturesque places, weather, temperature, currency, time and the like of the region. In addition, the information collected by the explorer having received the request from the requester, the request information (B) refers to information that the requester has requested the explorer to separately collect.

The explorer collects, in the region, the information requested from the requester, and transmits the information to the requester in real time. For example, a requester interested in Paris, France and having a plan to visit Paris may select an explorer currently located in Paris and request the explorer to collect basic information and requested information of the region. The explorer may take a picture of the Eiffel Tower in Paris, France and transmit the picture to the requester in real time and also transmit information on famous restaurants in Paris, France.

For this, the explorer terminal 121 transmits the collected information to the explorer information management server 160 in operation 290.

As the requester terminal 110 requests the explorer information management server 160 to provide the requested information in operation 300, the explorer information management server 160 provides the requested information in operation 310. Therefore, the requester terminal 110 can acquire and utilize the information collected by the explorer in real time. In addition, the requester terminal 110 can acquire the information from the explorer information management server 160 each time the information is necessary in the future.

Further, the requester terminal 110 evaluates the explorer through the information provided from the explorer and provides evaluation information to the explorer information management server 160 in operation 320. The explorer information management server 160 then stores the evaluation information and modifies the exploration reliability of the explorer.

Further, the explorer information management server 160 requests the billing information management server 150 to pay an exploration request cost in operation 330, and the billing information management server 150 pays the request cost in operation 340.

The present invention is different from conventional technology in that the information of the region in which the requester is interested can be acquired from explorers located in the region.

In particular, since information of any region can be acquired as long as an explorer is located in the region, there are no regional restrictions. Since a scheme of requesting desired information is used, a requester can be provided with desired information in a customized form.

In addition, since the requester pays a certain cost to the explorer as a reward for reception of requested information, active explorer participation can be induced. Thus, the user can acquire useful information in real time in advance without having to actually visit the region in which the user is interested or desires to travel.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of providing location-related information in a location information management server, the method comprising:
acquiring information related to a region in which one or more users are located, from the users in real time; and
providing the information related to the region acquired in real time to one or more users.

2. A method of providing location-related information in a location information management server, the method comprising:
receiving registration of current locations of explorers;
searching for the explorers in a specific region according to a request for search for the explorers in the specific region from a requester;
transmitting a list of explorers according to the search to a requester terminal;
requesting an explorer selected by the requester to provide information as explorer selection information is received from the requester terminal; and
receiving the information from the explorer and transmitting the information to the requester terminal.

3. The method according to claim 2, wherein the searching for the explorers includes searching for similar or excellent explorers.

4. The method according to claim 2, further comprising:
depositing a request cost received from the requester to a billing information management server; and
requesting the billing information management server to pay an exploration request cost to the explorer.

5. The method according to claim 2, further comprising:
receiving explorer evaluation information from the requester and modifying exploration reliability of the explorer.

6. A method of requesting location-related information in a requester terminal, the method comprising:
requesting a location information management server to provide a list of explorers;
selecting an explorer from the explorer list received from the location information management server;
requesting the selected explorer to perform exploration; and
requesting the location information management server to provide explorer collection information and receiving the explorer collection information.

7. The method according to claim 6, wherein the selecting includes selecting an explorer having excellent exploration reliability.

8. The method according to claim 6, wherein the selecting includes selecting an explorer having a similar inclination to the requester.

9. A location-based information providing system, the system comprising:
one or more requester terminals;
one or more explorer terminals located in a specific location and configured to hold information related to the region and register the information in a location information management server; and
a location information management server configured to provide location information received from the explorer terminals to the requester terminals.

10. The method according to claim 9, further comprising:
a billing information management server configured to manage settlement and payment of a cost that is paid when the requester requests the explorer to collect information.
